(19) United States
(12) Patent Application Publication
(10) Pub. No.: US 2010/0293197 A1
(43) Pub. Date: Nov. 18, 2010

(54) Directory Opportunistic Locks Using File System Filters

(75) Inventors: Roopesh C. Battepati, Sammamish, WA (US); Michael C. Johnson, Bothell, WA (US); Jeffrey K. Biseda, Seattle, WA (US); James T. Pinkerton, Sammamish, WA (US); David Matthew Kruse, Kirkland, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/465,682

(22) Filed: May 14, 2009

(51) Int. Cl. G06F 17/30; G06F 7/00

(52) U.S. Cl. 707/781; 707/822

(57) ABSTRACT

Aspects of the subject matter described herein relate to directory oplocks. In aspects, a file system filter is inserted in a filter stack between requesters of directory oplocks and a file system that stores file system objects. The file system filter receives requests for directory oplocks and subsequently monitors for requests to access file system objects that are inconsistent with the directory oplocks. To provide directory oplock mechanisms, the file system filter may use alternate data streams if provided by the file system or may independently maintain information usable to maintain and release directory oplocks. A directory oplock may affect ancestors and descendants of the directory depending on constraints imposed by the oplock.

### BACKGROUND

An opportunistic lock allows a process to obtain exclusive or non-exclusive access to a file. When another process seeks to obtain access to the file, a notification is sent to the process having the opportunistic lock. The process having the opportunistic lock may then release or otherwise modify its lock on the file.

A file system may distinguish between files and directories. A file system that provides opportunistic locking on files may not provide opportunistic locking on directories. Furthermore, such file systems may be embedded in a multitude of products that have already shipped. Providing an effective mechanism for opportunistic locking of directories in such shipped products and even non-shipped products without major updates to the products is challenging.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Briefly, aspects of the subject matter described herein relate to directory opportunistic locks (hereinafter sometimes referred to as “oplocks”). In aspects, a file system filter is inserted in a filter stack between requesters of directory oplocks and a file system that includes file system objects. The file system filter receives requests for directory oplocks and subsequently monitors for requests to access file system objects that are inconsistent with the directory oplocks. To provide directory oplock mechanisms, the file system filter may use alternate data streams if provided by the file system or may independently maintain information usable to maintain and release directory oplocks. A directory oplock may affect ancestors and descendants of the directory depending on constraints imposed by the oplock.

This Summary is provided to briefly identify some aspects of the subject matter that is further described below in the Detailed Description. This Summary is not intended to identify key or essential features of the claimed subject matter, nor is it intended to be used to limit the scope of the claimed subject matter.

The phrase “subject matter described herein” refers to subject matter described in the Detailed Description unless the context clearly indicates otherwise. The term “aspects” is to be read as “at least one aspect.” Identifying aspects of the subject matter described in the Detailed Description is not intended to identify key or essential features of the claimed subject matter.

The aspects described above and other aspects of the subject matter described herein are illustrated by way of example and not limited in the accompanying figures in which like reference numerals indicate similar elements and in which:

### BRIEF DESCRIPTION OF THE DRAWINGS

FIG. 1 is a block diagram representing an exemplary general-purpose computing environment into which aspects of the subject matter described herein may be incorporated;

FIG. 2 is a block diagram representing an exemplary arrangement of components of a system that may operate in accordance with aspects of the subject matter described herein;

FIG. 3 is a block diagram representing another exemplary arrangement of components of a system that may operate in accordance with aspects of the subject matter described herein;

FIG. 4 is a block diagram representing another exemplary arrangement of components of a system that may operate in accordance with aspects of the subject matter described herein;

FIG. 5 is a block diagram representing an exemplary arrangement of components of a system that operates in accordance with aspects of the subject matter described herein; and

FIG. 6 is a flow diagram that generally represents one set of exemplary actions that may occur in obtaining a directory oplock in accordance with aspects of the subject matter described herein;

FIG. 7 is a flow diagram that generally represents exemplary actions that may occur in determining whether to grant access to another requester in accordance with aspects of the subject matter described herein; and

FIG. 8 is a flow diagram that generally represents another set of exemplary actions that may occur in obtaining a directory oplock in accordance with aspects of the subject matter described herein.

### DETAILED DESCRIPTION

### Definitions

As used herein, the term “includes” and its variants are to be read as open-ended terms that mean “includes, but is not limited to.” The term “or” is to be read as “and/or” unless the context clearly dictates otherwise. The term “based on” is to be read as “based at least in part on.” Other definitions, explicit and implicit, may be included below.

### Exemplary Operating Environment

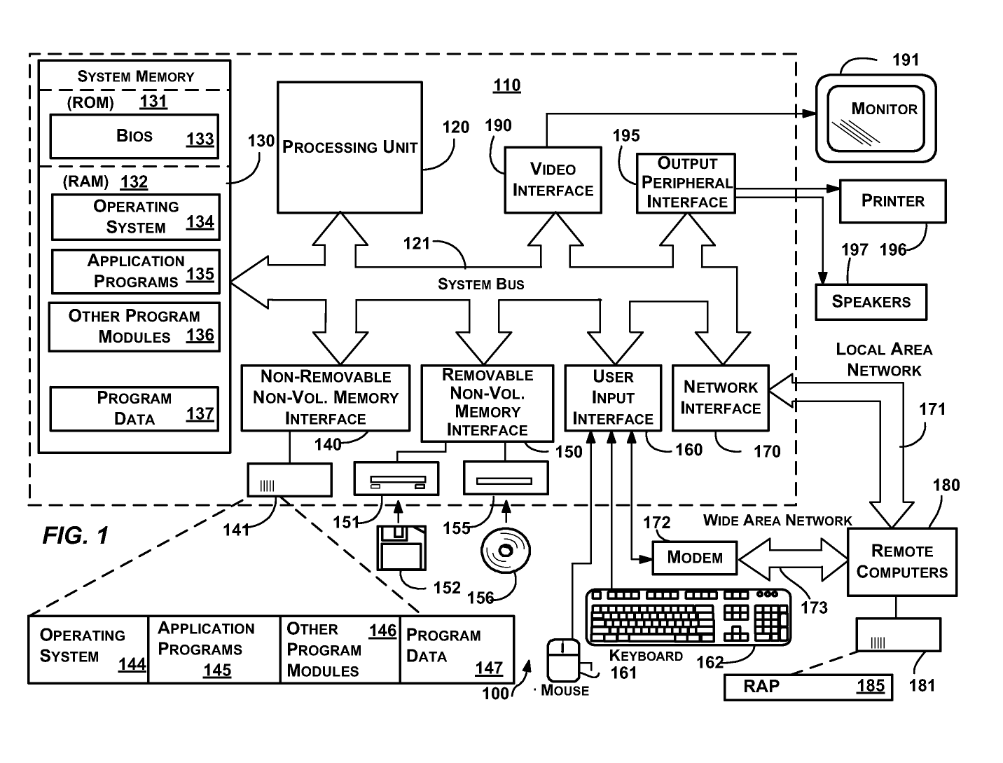

FIG. 1 illustrates an example of a suitable computing system environment 100 on which aspects of the subject matter described herein may be implemented. The computing system environment 100 is only one example of a suitable computing environment and is not intended to suggest any limitation as to the scope of use or functionality of aspects of the subject matter described herein. Neither should the computing environment 100 be interpreted as having any dependency or requirement relating to any one or combination of components illustrated in the exemplary operating environment 100.

Aspects of the subject matter described herein are operational with numerous other general purpose or special purpose computing system environments or configurations. Examples of well known computing systems, environments, or configurations that may be suitable for use with aspects of the subject matter described herein comprise personal computers, server computers, hand-held or laptop devices, multiprocessor systems, microcontroller-based systems, set top boxes, programmable consumer electronics, network PCs, minicomputers, mainframe computers, personal digital assistants (PDAs), gaming devices, printers, appliances including set-top, media center, or other appliances, automobile-embedded or attached computing devices, other mobile devices, distributed computing environments that include any of the above systems or devices, and the like.

Aspects of the subject matter described herein may be described in the general context of computer-executable instructions, such as program modules, being executed by a computer. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing aspects of the subject matter described herein includes a general-purpose computing device in the form of a computer 110. A computer may include any electronic device that is capable of executing an instruction. Components of the computer 110 may include a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, Peripheral Component Interconnect Extended (PCI-X) bus, Advanced Graphics Port (AGP), and PCI express (PCIe).

The computer 110 typically includes a variety of computer-readable media. Computer-readable media can be any available media that can be accessed by the computer 110 and includes both volatile and nonvolatile media, and removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules, or other data. Computer storage media includes RAM, ROM, EEPROM, flash memory or other memory technology, CD-ROM, digital versatile discs (DVDs) or other optical disk storage, magnetic cassettes, magnetic tape, magnetic disk storage or other magnetic storage devices, or any other medium which can be used to store the desired information and which can be accessed by the computer 110.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disc drive 155 that reads from or writes to a removable, nonvolatile optical disc 156 such as a CD ROM or other optical media. Other removable/non-removable, volatile/nonvolatile computer storage media that can be used in the exemplary operating environment include magnetic tape cassettes, flash memory cards, digital versatile discs, other optical discs, digital video tape, solid state RAM, solid state ROM, and the like. The hard disk drive 141 is typically connected to the system bus 121 through a non-removable memory interface such as interface 140, and magnetic disk drive 151 and optical disc drive 155 are typically connected to the system bus 121 by a removable memory interface, such as interface 150.

The drives and their associated computer storage media, discussed above and illustrated in FIG. 1, provide storage of computer-readable instructions, data structures, program modules, and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers herein to illustrate that, at a minimum, they are different copies.

A user may enter commands and information into the computer 20 through input devices such as a keyboard 162 and pointing device 161, commonly referred to as a mouse, trackball, or touch pad. Other input devices (not shown) may include a microphone, joystick, game pad, satellite dish, scanner, a touch-sensitive screen, a writing tablet, or the like. These and other input devices are often connected to the processing unit 120 through a user input interface 160 that is coupled to the system bus, but may be connected by other interface and bus structures, such as a parallel port, game port or a universal serial bus (USB).

A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 may include a modem 172 or other means for establishing communications over the WAN 173, such as the Internet. The modem 172, which may be internal or external, may be connected to the system bus 121 via the user input interface 160 or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

### Filters

With contemporary operating systems, such as Microsoft Corporation's Windows® Vista operating system with an underlying file system such as the Windows® NTFS (Windows® NT File System), FAT, CDFS, SMB redirector file system, or WebDav file systems, one or more file system filter drivers may be inserted between the I/O manager that receives user I/O requests and the file system driver. In general, filter drivers (sometimes referred to herein simply as “filters”) are processes that enhance the underlying file system by performing various file-related computing tasks that users desire, including tasks such as passing file system I/O (requests and data) through anti-virus software, file system quota monitors, file replicators, and encryption/compression products.

For example, antivirus products may provide a filter that watches I/O to and from certain file types (.exe, .doc, and the like) looking for virus signatures, while file replication products perform file system-level mirroring. Other types of file system filter drivers are directed to system restoration (which backs up system files when changes are about to be made so that the user can return to the original state), disk quota enforcement, backup of open files, undeletion of deleted files, encryption of files, and so forth. Thus, by installing file system filter drivers, computer users can select the file system features they want and need, in a manner that enables upgrades, replacement, insertion, and removal of the components without changing the actual operating system or file system driver code.

The term “process” and its variants as used herein may include one or more traditional processes, threads, components, libraries, objects that perform tasks, and the like. A process may be implemented in hardware, software, or a combination of hardware and software. In an embodiment, a process is any mechanism, however called, capable of or used in performing an action. A process may be distributed over multiple devices or a single device. In one embodiment, an entity comprises a process as defined above. In another embodiment, an entity comprises any one or more objects that is/are capable of performing actions associated with or using one or more processes.

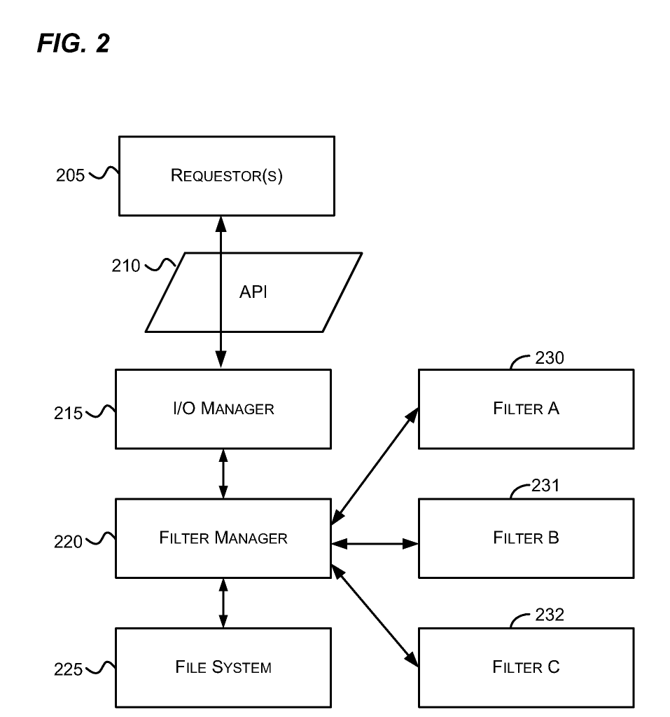

FIG. 2 is a block diagram representing an exemplary arrangement of components of a system that may operate in accordance with aspects of the subject matter described herein. The components include one or more requesters 205, an applications programming interface (API) 210, an input/output (I/O) manager 215, a filter manger 220, a file system 225, and one or more filters 230-232.

In one embodiment, a requester may comprise a local process such as an application, service, or the like that seeks to access a directory oplock or a file system object affected by a directory oplock. In another embodiment, a requester may comprise a process that performs work on behalf of another process (e.g., a process executing on an apparatus other than the apparatus upon which the file system filter executes). For example, a requester may comprise a service that provides access to a remote computer that seeks to access file system objects on the file system 225.

Accessing an oplock as used herein may include obtaining an oplock, modifying an oplock, releasing an oplock, some combination of two or more of the above, and the like. Similarly, accessing a file system object may include reading the file system object, writing data to the file system object, deleting data from the file system object, updating data in the file system object, a combination of two or more of the above, and the like. directory oplock

The requesters 205 may make file system requests (e.g., via function/method calls) through the API 210 to the I/O manager 215. The I/O manager 215 may determine what I/O request or requests to issue to fulfill each request and send each I/O request to the filter manager 220. The I/O manager 215 may also return data to the requesters 205 as operations associated with the file system requests proceed, complete, or abort.

In one implementation, filters comprise objects or the like that when instantiated register (e.g., during their initialization procedure) with a registration mechanism in the filter manager 220. For efficiency, a filter may register for file system requests in which it may be interested in processing. To this end, as part of registration, each filter notifies the filter manager 220 of the types of I/O requests in which it is interested (e.g., create, read, write, close, rename, and so forth). For example, an encryption filter may register for read and write I/Os, but not for others wherein data does not need to be encrypted or decrypted. Similarly, a quota filter may be interested only in object creates, object deletes, object writes, and other operations that may cause on-disk allocation change of a file.

In addition to specifying the types of I/O requests in which it is interested, a filter may further specify whether the filter should be notified for pre-callbacks and post-callbacks for each of the types of I/O. A pre-callback is called as data associated with an I/O request propagates from the I/O manager 215 towards the file system 225, while a post-callback is called during the completion of the I/O request as data associated with the I/O request propagates from the file system 225 towards the I/O manager 215.

From each I/O request, the filter manager 220 may create a data structure in a uniform format suitable for use by the filters 230-232. Hereinafter, this data structure is sometimes referred to as callback data. The filter manager 220 may then call and pass the callback data to each filter that has registered to receive callbacks for the type of I/O received by the filter manager 220. Filters registered to receive callbacks for the type of I/Os received by the filter manager are sometimes referred to as mini filters.

The filter manager 220 may pass callback data associated with a particular type of I/O request to each registered filter sequentially in an order in which the registered filters are ordered. For example, if the filters 230 and 232 are registered to receive callbacks for all read I/O requests and are ordered such that the filter 230 is before the filter 232 in processing such requests, then after receiving a read I/O, the filter manager 220 may first call and pass the callback data to the filter 230 and after the filter 230 has processed the callback data, the filter manager 220 may then call and pass the callback data (as modified, if at all) to the filter 232.

A filter may be attached to one or more volumes. That is, a filter may be registered to be called and receive callback data for I/Os related to only one or more than one volumes.

A filter may generate its own I/O request which may then be passed to other filters. For example, an anti-virus filter may wish to read a file before it is opened by a requesting process. A filter may stop an I/O request from propagating further and may instruct the filter manager to report a status code (e.g., success or failure) for the I/O request. A filter may store data in memory and persist this data on disk. In general, a filter may be created to perform any set of actions that may be performed by a kernel-mode or user-mode process and may be reactive (e.g., wait until it receives I/O requests before acting) and/or proactive (e.g., initiate its own I/O requests or perform other actions asynchronously with I/O requests handled by the I/O manager 215).

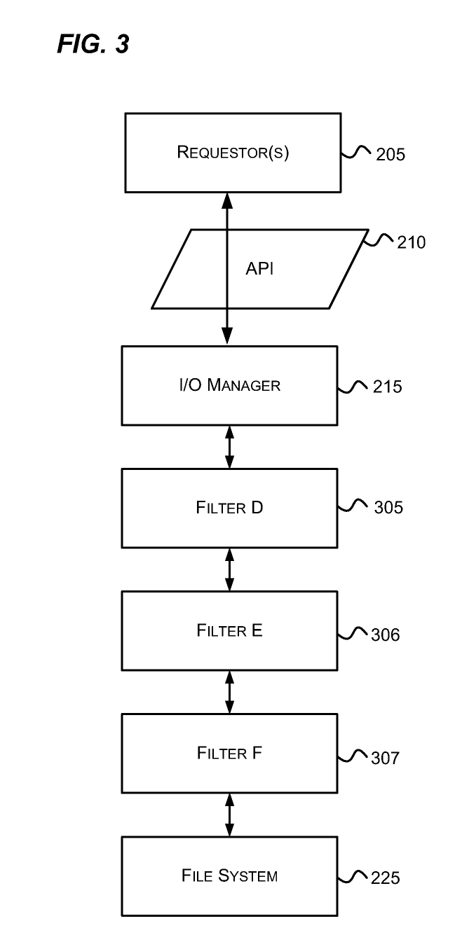

In one embodiment, filters may be arranged in a stacked manner as illustrated in FIG. 3, which is a block diagram representing another exemplary arrangement of components of a system that may operate in accordance with aspects of the subject matter described herein. In this embodiment, each of the filters 305-307 may process I/O requests and pass the requests (modified or unmodified) to another filter or other component in the stack. For example, in response to a read request received from one of the requesters 205, the I/O manager 215 may issue an I/O request and send this request to the filter 305. The filter 305 may examine the I/O request and determine that the filter 305 is not interested in the I/O request and then pass the I/O request unchanged to the filter 306. The filter 306 may determine that the filter 306 will perform some action based on the I/O request and may then pass the I/O request (changed or unchanged) to the filter 307. The filter 307 may determine that the filter 307 is not interested in the I/O request and pass the I/O request to the file system 225. The file system 225 may operate on one or more volumes that may be located locally or remotely to the machine or machines upon which the requesters 205 execute

After the file system 225 services the I/O request, it passes the results to the filter 307. The results may pass in an order reverse from that in which the I/O request proceeded (e.g., first to filter 307, then to filter 306, and then to filter 305). Each of the filters 305-307 may examine the results, determine whether the filter is interested in the results, and may perform actions based thereon before passing the results (changed or unchanged) on to another filter or component.

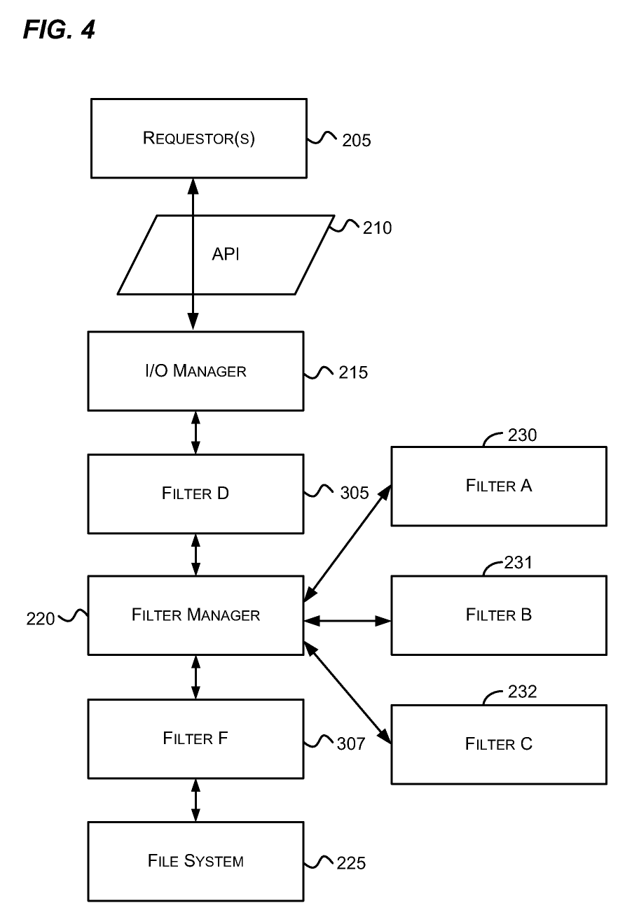

In another embodiment, filters may be arranged in a stacked/managed manner as illustrated in FIG. 4, which is a block diagram representing another exemplary arrangement of components of a system that may operate in accordance with aspects of the subject matter described herein. In this configuration, some filters are associated with a filter manager while other filters are not. Filters that are associated with a filter manager (e.g., filters 230-232) are sometimes referred to herein as mini filters while filters that are not associated with a filter manager (e.g., filters 305 and 307) are sometimes referred to herein as legacy filters. The filter manager 220 is placed in a stack with other filters (e.g., filters 305 and 307).

It will be readily recognized that filters may be implemented in many other configurations without departing from the spirit or scope of aspects of the subject matter described herein. In some embodiments, a filter comprises any object that is given an opportunity to examine I/O between a requester and a file system and that is capable of changing, completing, or aborting the I/O or performing other actions based thereon.

### Filters and OpLocks

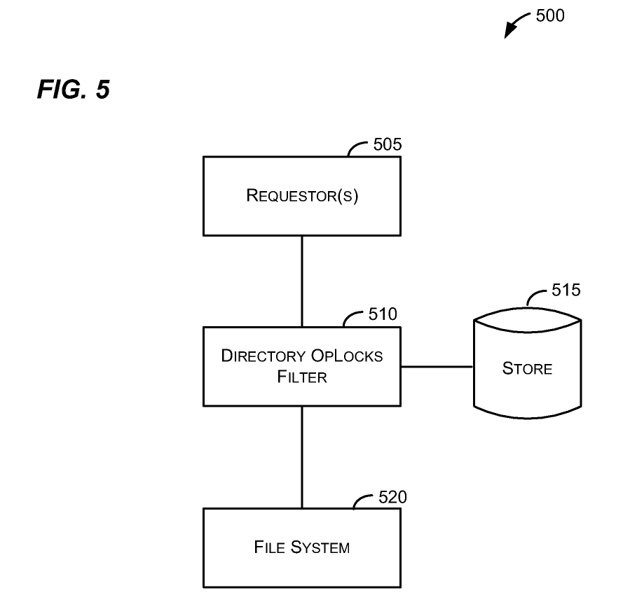

As mentioned previously, a file system that provides opportunistic locking on files may not provide opportunistic locking on directories. FIG. 5 is a block diagram representing an exemplary arrangement of components of a system that operates in accordance with aspects of the subject matter described herein. The components illustrated in FIG. 5 are exemplary and are not meant to be all-inclusive of components that may be needed or included. In other embodiments, the components and/or functions described in conjunction with FIG. 5 may be included in other components (shown or not shown) or placed in subcomponents without departing from the spirit or scope of aspects of the subject matter described herein.

The components of the system 500 may be included on a single apparatus (e.g., the computer 110 of FIG. 1) or may be distributed across two or more apparatuses. As illustrated in FIG. 5, the system 500 includes one or more requesters 505, a directory oplocks filter 510, a store 515, and a file system 520.

The store 515 may comprise any storage media capable of storing data. For example, the store 515 may comprise non-volatile memory such as a hard disk, volatile memory such as RAM, other storage media described in conjunction with FIG. 1, other storage, some combination of the above, and the like and may be distributed across multiple devices. The store 515 may be external, internal, or include components that are both internal and external to a device hosting the entities illustrated in FIG. 5.

The file system 520 is a mechanism for organizing and providing access to file system objects. As used herein a file system object may include a directory or a file. Herein, a file system object is sometimes referred to simply as an object. The file system 520 may interface with volatile or non-volatile memory to access objects. The file system 520 may organize objects in a hierarchical manner in which a directory includes zero or more other objects.

The one or more requesters 505 comprise entities that seek to obtain, modify, or release an oplock as well as entities that seek to access file system objects. A requester may, but need not be, an entity that initiates a request. For example, a requester may act to provide access to an entity that is included on the apparatus that hosts the system 500 or to an entity that is on a different apparatus. As used herein, the term entity is to be read to include all or a portion of a device, one or more software components executing on one or more devices, some combination of one or more software components and one or more devices, and the like.

The directory oplocks filter 510 (hereinafter sometimes referred to as the oplocks filter 510) may comprise a legacy, managed, or some other type of filter described previously and may be in a filter stack with one or more other filters (not shown). In operation, the oplocks filter 510 may be configured to monitor for access requests that may affect directory oplocks. In one embodiment, the oplocks filter 510 may allow other mechanisms (e.g., the file system 520) to handle oplocks on files. In another embodiment, the oplocks filter 510 may handle oplocks on both files and directories.

In one embodiment, an access affects a directory oplock when the access is to the directory or any of if its ancestors or descendants and if the access is inconsistent with the directory oplock. Ancestors of the directory include the directory, if any, that includes the directory, the directory, if any, that includes that directory, and so forth back to the root directory. Descendants of the directory include any objects in the directory, any objects that are included in any directories included in the directory, and so forth. A namespace may indicate a directory, descendants of the directory, ancestors of the directory, or a combination of two or more of the above.

An access is inconsistent with the directory oplock if it violates some constraint of the directory oplock. For example, a directory oplock may indicate that the requester is to have exclusive access to the directory and its ancestors and descendants. In this case, if another requester seeks to access the directory or its ancestors or descendants, the access is inconsistent with the directory oplock. As another example, a directory oplock may indicate that the requester is to have non-exclusive read access to the directory and its ancestors or descendants but that other requesters may also read from the directory or its ancestors or descendants but not rename, change, delete, or otherwise access the directory or its ancestors or descendants.

A directory oplock may just be to the directory itself and may not be affected by access requests to its ancestors or descendants. In this case, an access request is inconsistent if the access request is to the directory object itself and violates some constraint of the directory oplock.

Some file systems allow multiple streams of data to be associated with the same file system object. For example, one stream of a file may include video data associated with the file while another stream of the file may include commentary data regarding the video data. A file system that allows oplocks on files but not directories may allow oplocks on alternate streams of a file system object.

At least one of the streams associated with a file system object is a default data stream. All other streams, if any, associated with the file system object are alternate data streams of the file system object. A default data stream is a data stream of the file system object that is accessed by default without needing to explicitly specify the data stream (e.g., with a stream name, identifier, or otherwise). An alternate data stream is accessed by explicitly indicating a non-default data stream associated with the file system object. The explicit indication of the alternate data stream (e.g., via a name, identifier, or otherwise) may be needed to avoid indicating a default data stream associated with the file system object.

In file systems that support alternate data streams in one embodiment, the oplocks filter 510 may monitor I/O requests for oplocks that are proceeding toward the file system 520. When an I/O request for an oplock is for a directory, the oplocks filter 510 may intercept the request, store information indicative of a namespace associated with the directory, and may monitor subsequent requests to determine if they are inconsistent with the oplock. Storing information indicative of a namespace may include storing a path of a directory and information that indicates whether ancestors and/or descendants of the directory are involved in the oplock.

The subsequent requests may be to one or more file system objects within the namespace. Where a file system supports oplocks on alternate data streams, the oplock request may then be sent to the file system 520 which may then grant the request as if the request had been for an oplock to a data stream of a file object of the file system 520.

From the point of view of the file system 520, an oplock request on an alternate data stream may be no different than an oplock request on the default (e.g., unnamed) data stream of a file. Also, the file system 520 may treat the alternate data stream for a directory in the same way as an alternate data stream for a file.

In one embodiment, after a requester requests an oplock operation on an alternate data stream of a directory, subsequent operations to the directory are examined by the oplocks filter 510 and processed such that oplock semantics similar to a file oplock are maintained except for a directory. There are at least two ways this can be done.

In an embodiment, the oplocks filter 510 may intercept any operations that might lead to a change in the state of a directory (e.g., file creation, deletion, renaming, other file operations, and the like) and attempt to acquire an oplock on an alternate data stream of the directory. Doing this leads to a break request being generated by the file system 520 for the current holder of the oplock on that stream. A break request is a message that asks a current holder of an oplock to modify or release its oplock. The current holder may comply with the request or indicate that it will not release or modify the oplock.

When the oplocks filter 510 receives the break request generated by the file system, the oplocks filter 510 may then format the break request, if needed, into a format suitable for the oplocks holder and forward the break request to the oplocks holder. After the oplocks holder responds to the oplock break request, the oplocks filter 510 may examine the response and adjust its data structure regarding the state of the oplock, if needed. The response may then be forwarded to the file system 520.

In another embodiment, when the oplocks filter 510 receives any operations which might lead to a change in the state of a directory, rather forwarding the request to the file system, the oplocks filter 510 may initiate an oplock break request directly by sending such a request to the oplocks holder that currently has an oplock on the directory.

In this embodiment, the oplocks filter 510 may include logic for maintaining oplock information for each directory oplock requested by the one or more requesters 505. The oplock information may include a namespace associated with the directory. Independent of oplock mechanisms, if any, that may be provided on the file system 520, the oplocks filter 510 may include oplock logic to grant and release directory oplocks as well as logic to request that an oplock on a directory be released or modified. The oplock logic may store tuples that include oplock information and namespaces associated with the oplock information. For example, the oplock information may include an identifier associated with (e.g., that indicates) a requester, an identifier associated with (e.g., that indicates) a namespace, and information that indicates constraints of the oplock.

To allow for directory oplocks on a directory hierarchy (e.g. for a directory oplock that involves a directory and its ancestors and/or descendants) the oplocks filter 510 may also monitor operations on files and directories within the hierarchy. In doing this, the oplocks filter 510 may determine whether or not a requested operation affects an object in the hierarchy in a manner inconsistent with a granted oplock, and if so, the oplocks filter 510 may then initiate oplock break processing in a similar way as has been described above for a single directory.

To improve performance for directory oplocks on a directory hierarchy, the oplocks filter 510 may employ a caching strategy that records previous determinations as to whether or not a requested object is within the hierarchy. The store 515 may provide access to a cache used by the oplocks filter 510.

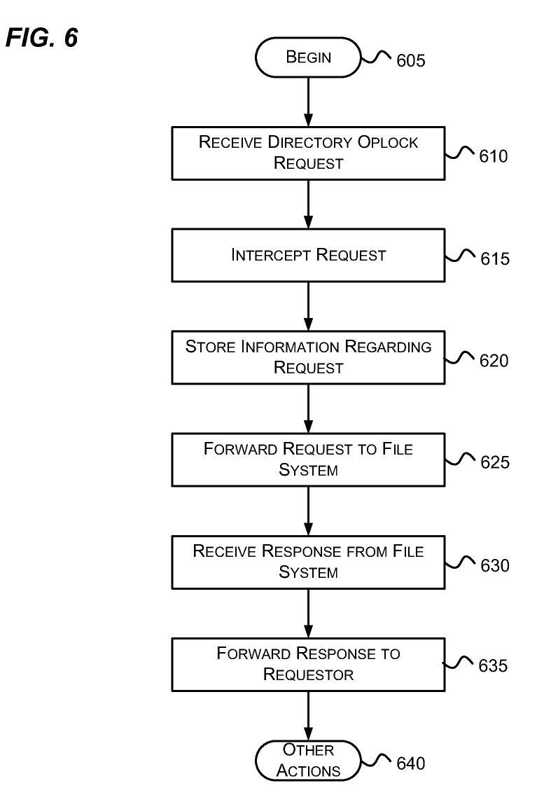

FIGS. 6-8 are flow diagrams that generally represent actions that may occur in accordance with aspects of the subject matter described herein. For simplicity of explanation, the methodology described in conjunction with FIGS. 6-8 is depicted and described as a series of acts. It is to be understood and appreciated that aspects of the subject matter described herein are not limited by the acts illustrated and/or by the order of acts. In one embodiment, the acts occur in an order as described below. In other embodiments, however, the acts may occur in parallel, in another order, and/or with other acts not presented and described herein. Furthermore, not all illustrated acts may be required to implement the methodology in accordance with aspects of the subject matter described herein. In addition, those skilled in the art will understand and appreciate that the methodology could alternatively be represented as a series of interrelated states via a state diagram or as events.

FIG. 6 is a flow diagram that generally represents one set of exemplary actions that may occur in obtaining a directory oplock in accordance with aspects of the subject matter described herein. Turning to FIG. 6, at block 605, the actions begin.

At block 610, a request for an oplock on a directory is received. For example, referring to FIG. 5, the oplocks filter 510 receives a request for an oplock on one of the directories of the file system 520. The request may be received from an I/O manager, a filter manager, or a filter higher in the stack than the oplocks filter 510. The request may be for an oplock to the directory and to ancestors and descendants of the directory or just for an oplock to the directory. The request may include constraints of the access requested (exclusive, read-only, etc.).

The request is associated with a requester and is directed to a file system that may natively support oplocks on files but not on directories. Natively support in this context means that the file system has a mechanism (not included in the filter 510) for granting, releasing, and modifying oplocks on files within the file system 520.

At block 615, the filter intercepts (e.g., examines) the request. For example, referring to FIG. 5, the oplocks filter 510 intercepts the request for the directory oplock that is proceeding toward the file system 520.

At block 620, the filter stores information regarding the request. For example, referring to FIG. 5, the oplocks filter 510 may store information indicative of a namespace to be monitored by the file system filter for subsequent requests that are potentially inconsistent with the oplock. In some embodiments, some or all of this information may be stored after the actions associated with block 630 and before the actions associated with block 635. This may be done, for example, for efficiency to wait until after it is known whether the file system has granted the oplock.

At block 625, the request is forwarded to the file system. For example, referring to FIG. 5, the oplocks filter 510 forwards the request to the file system 520.

At block 630, a response to the request is received from the file system. For example, referring to FIG. 5, the oplocks filter 510 receives a response to the request from the file system 520.

At block 635, the response is forwarded to the requester. For example, referring to FIG. 5, the oplocks filter 520 sends the response received from the file system 520 to the requester that requested the oplock.

At block 640, other actions, if any, are performed.

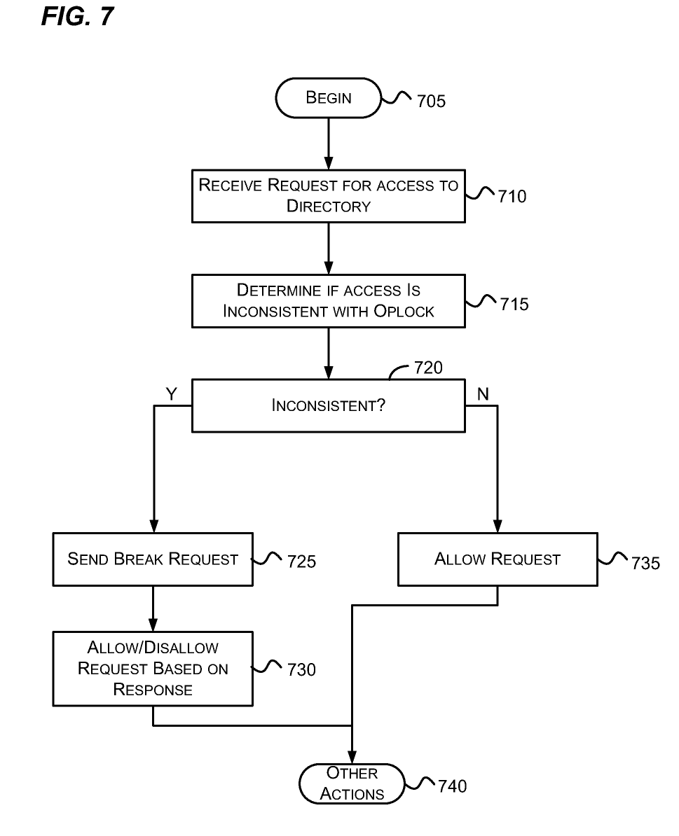

FIG. 7 is a flow diagram that generally represents exemplary actions that may occur in determining whether to grant access to another requester in accordance with aspects of the subject matter described herein. At block 705, the actions begin.

At block 710, a request for access is received to a directory or to one of its ancestors or descendants. For example, referring to FIG. 5, a request is received at the oplocks filter 510 from one of the requesters 505. The request may be for access to a directory that has an oplock on it.

At block 715, a determination is made as to whether the access is inconsistent with the oplock on the directory. For example, referring to FIG. 5, in one embodiment, the oplocks filter 510 may send a request for access to the directory using an alternate data stream of the directory. The response from the file system indicates whether the access is inconsistent with the oplock. In another embodiment, the oplocks filter 510 may consult oplocks information on the store 515 without consulting the file system 520 to determine whether the access violates any constraint of the oplock.

At block 720, if the access is inconsistent with the oplock, the actions continue at block 725; otherwise, the actions continue at block 735.

At block 725, a break request is sent. For example, referring to FIG. 5, a break request is sent from the oplocks filter 510 to the oplocks owner that currently has the oplock on the directory. In one embodiment, the break request is sent after receiving a break request from the file system 520. In another embodiment, the break request is sent by the oplocks filter 510 without going through the process of obtaining a break request from the file system 520.

At block 730, the request for access to the directory is allows or disallowed based on the response to the break request. For example, referring to FIG. 5, if the oplocks filter 510 receives a response that indicates that the requester with the oplock is releasing or modifying the oplock, the oplocks filter 510 may allow the request to access the directory.

At block 735, as the access request is not inconsistent with constraints on the directory, the access request is allowed.

At block 740, other actions, if any, are performed.

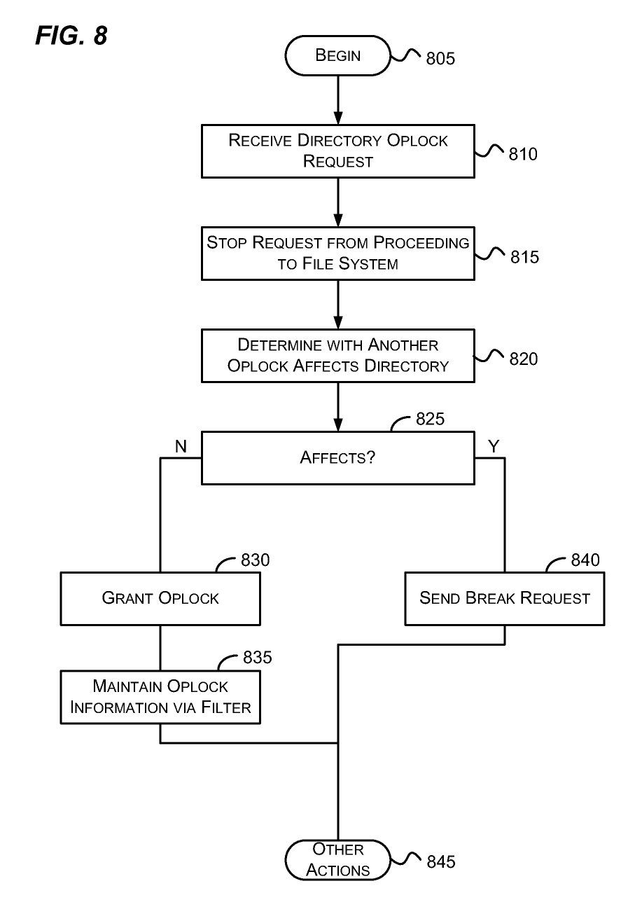

FIG. 8 is a flow diagram that generally represents another set of exemplary actions that may occur in obtaining a directory oplock in accordance with aspects of the subject matter described herein. Turning to FIG. 8, at block 805, the actions begin.

At block 810, a request for an oplock on a directory is received. For example, referring to FIG. 5, the oplocks filter 510 receives a request for an oplock on a directory of the file system 520.

At block 815, the request is stopped from propagating to the file system. For example, referring to FIG. 5, the oplocks filter 510 stops the request from propagating toward the file system 520.

At block 820, a determination is made as to whether another oplock affects the directory. Affects as used in this context means that another oplock has constraints that constrain access to the directory in a manner which is inconsistent with the requested oplock. For example, referring to FIG. 5, the oplocks filter 510 determines whether the directory is an ancestor or descendant of another directory that has an oplock on it that constrains ancestors and/or descendants. The oplocks filter 510 may also determine whether an oplock is already on the directory for which the requester is seeking an oplock.

At block 825, if another oplock affects the request for an oplock, the actions continue at block 840; otherwise, the actions continue at block 830.

At block 830, the oplock is granted. For example, referring to FIG. 5, the oplocks filter 510 grants a directory oplock to the requesting requester.

At block 835, information about the oplock is maintained via the filter. For example, referring to FIG. 5, the oplocks filter 510 may store an identifier associated with the requester, an identifier associated with the directory, and information that indicates constraints of the oplock.

At block 840, a break request is sent to a requester that has an oplock on the directory. For example, referring to FIG. 5, the oplocks filter 510 may send a break request to one or more requesters 505 that have an oplock on the directory for which the oplock is sought.

At block 845, other actions, if any, are performed.

As can be seen from the foregoing detailed description, aspects have been described related to directory oplocks. While aspects of the subject matter described herein are susceptible to various modifications and alternative constructions, certain illustrated embodiments thereof are shown in the drawings and have been described above in detail. It should be understood, however, that there is no intention to limit aspects of the claimed subject matter to the specific forms disclosed, but on the contrary, the intention is to cover all modifications, alternative constructions, and equivalents falling within the spirit and scope of various aspects of the subject matter described herein.

What is claimed is:

1. A method implemented at least in part by a computer, the method comprising:
receiving, at a file system filter, a first request for an oplock on an alternate data stream of a directory, the first request associated with a requester, the first request being directed to a file system that natively supports oplocks on files but not on directories, the file system filter having an opportunity to examine communications between the requester and the file system;
storing information indicative of a namespace to be monitored by the file system filter for subsequent requests that are potentially inconsistent with the oplock;
forwarding the first request toward the file system;
receiving, from the file system, a response to the first request; and
forwarding the response to the requester.

2. The method of claim 1, wherein receiving, at a file system filter, a first request for an oplock on an alternate data stream of directory comprises receiving the first request from another file system filter higher in a filter stack.

3. The method of claim 1, wherein receiving a first request for an oplock on an alternate data stream of a directory comprises receiving a request for exclusive access to the directory but not for exclusive access to ancestors or descendants of the directory.

4. The method of claim 1, wherein receiving a first request for an oplock on a directory comprises receiving a request for exclusive access to the directory and for exclusive access to ancestors and descendants of the directory.

5. The method of claim 1, further comprising:
receiving a second request for access to a file system object of the namespace;
determining whether the access is consistent with the oplock;
if the access is inconsistent with the oplock, sending a break request; and
if the access is consistent with the oplock, allowing the request.

6. The method of claim 5, wherein sending a break request comprises sending a message to the requester, the message indicating that another requester seeks access that is inconsistent with the oplock.

7. The method of claim 5, wherein sending a break request is done in response to receiving another break request from the file system, the other break request being associated with the alternate data stream.

8. The method of claim 1, wherein storing information indicative of a namespace comprises storing a path of a directory and information that indicates whether ancestors and/or descendants of the directory are involved in the oplock.

9. The method of claim 1, wherein receiving a first request for an oplock on an alternate data stream of a directory comprises receiving an explicit indication of the alternate data stream, the explicit indication needed to avoid requesting an oplock on a default data stream associated with the directory.

10. The method of claim 1, wherein receiving a response to the first request comprises receiving a response that indicates that an oplock has already been granted on the alternate data stream and wherein forwarding the response comprises indicating to the requester that an oplock is not available for the directory.

11. The method of claim 1, further comprising associating the file system filter with a filter manager.

12. The method of claim 1, wherein receiving a first request for an oplock on an alternate data stream of the directory comprises receiving a request for an oplock on the directory and its ancestors and descendants.

13. The method of claim 1, wherein receiving a first request for an oplock on an alternate data stream of the directory comprises receiving a request for an oplock on the directory only without constraints on ancestors or descendants of the directory.

14. A computer storage medium having computer-executable instructions, which when executed perform actions, comprising:
receiving, at a file system filter, a first request for an oplock on a directory, the first request associated with a requester, the first request being directed to a file system, the file system filter having an opportunity to examine communications between the requester and the file system;
stopping the first request from propagating toward the file system;
determining whether another oplock affects the directory; and
if another oplock does not affect the directory, granting the oplock and maintaining, via the file system filter, information usable to indicate that the requester has the oplock on the directory.

15. The computer storage medium of claim 14, wherein maintaining, via the file system filter, information usable to indicate that the requester has the oplock on the directory comprises storing an identifier associated with the requester, an identifier associated with the directory, and information that indicates constraints of the oplock.

16. The computer storage medium of claim 14, further comprising if the other oplock does affect the directory, sending a break request to a requester associated with the other oplock.

17. In a computing environment, an apparatus, comprising:
a file system operable to provide access to file system objects, each file system object including a directory or a file;
a requester operable to request a directory oplock on a directory of the file system; and
a file system filter operable to store information indicative of a namespace associated with the directory and to monitor for subsequent requests that are potentially inconsistent with the oplock, the subsequent requests involving one or more file system objects within the namespace.

18. The apparatus of claim 17, wherein the requester is operable to request a directory oplock on a directory by being operable to request an oplock on an alternate data stream of the directory.

19. The apparatus of claim 17, wherein the file system filter is operable to monitor for subsequent requests that are potentially inconsistent with the oplock by accessing a store associated with the file system filter, the store including zero or more tuples that include oplock information and the information indicative of the namespace, the store maintained by the file system filter independently of any oplocks mechanism, if any, provided by the file system.

20. The apparatus of claim 17, wherein the file system is natively operable to provide oplocks on file system objects that are files but not to provide oplocks on file system objects that are directories.
